(19) United States
(12) Patent Application Publication
(10) Pub. No.: US 2025/0355149 A1
(43) Pub. Date: Nov. 20, 2025

(54) HIGH-PERFORMANCE SIGNAL-FRIENDLY SOLAR-CONTROL FILMS

(71) Applicant: EASTMAN PERFORMANCE FILMS, LLC, ST. LOUIS, MO (US)

(72) Inventors: JAIME ANTONIO LI, MARTINSVILLE, VA (US); DAVID LEE RICHARDSON, STUART, VA (US); COBY LEE HUBBARD, PATRICK SPRINGS, VA (US)

(73) Assignee: EASTMAN PERFORMANCE FILMS, LLC, ST. LOUIS, MO (US)

(21) Appl. No.: 18/853,833

(22) PCT Filed: Apr. 4, 2023
(86) PCT No.: PCT/US2023/065299

§ 371 Date: Oct. 3, 2024

Related U.S. Application Data
(60) Provisional application No. 63/328,393, filed on Apr. 7, 2022.

(51) Int. Cl. G02B 5/20; G02B 1/04; G02B 5/28

(52) U.S. Cl. CPC G02B 5/208; G02B 1/04; G02B 5/282

(57) ABSTRACT

Solar-control films are disclosed that include a first dielectric stack having: alternating layers of high and low refractive index materials of a first equal optical thickness; and at least one layer that is an odd multiple of the first equal optical thickness, wherein the first dielectric stack has a reflection band centered at a wavelength from 800 nm to 1500 nm; and a second dielectric stack, optically adjacent the first dielectric stack, having: alternating layers of high and low refractive index materials of a second equal optical thickness; and at least a single layer that is an even multiple of the second equal optical thickness.

### BACKGROUND OF INVENTION

There is a current need for solar control films that are highly transmissive in the visible range, based on reflective technology, and compatible with radio-frequency transmissions from electronic devices. Electronics compatibility has become a very important factor in window film products. The current highest performance commercial solar reflector is based on a multilayer film that contains silver layers. However, it is not fully compatible with current electronic devices due to RF signal blocking.

High performance window films based on selective-absorption technologies are also available. However, they are lower in performance compared to metal-based reflectors because the solar energy absorbed is re-radiated on both sides of the glazing.

Dielectric solar control films based on infra-red reflectors (IRR) are also available. The typical dielectric IRR is built from a quarter-wave stack of optical materials having high and low refractive indices tuned to reflect a band within the NIR section of the solar energy spectrum. These dielectric IRRs have a reflection band of limited width and are difficult to construct. The IRR bands typically cover a narrower section of the NIR that is part of the solar spectrum.

U.S. Pat. No. 3,279,317 discloses extending the effective range of a heat reflection filter toward longer waves and further narrowing the gap which is present up to the minimum wavelength of glass absorption at approximately 2.5μ in the effective radius of heat reflection filters. This reference is especially concerned with heat generated by lamps that are a source of a low color temperature. According to this disclosure, the width of the transmission (or low reflection) band is limited to approximately 280 nm within the visible light spectrum. This is not a problem for projection systems, since the disclosure relates to eliminating lamp heat, and does not relate to infrared reflectors for solar control that are viewed at higher angles of incidence, such as 30 or 45 degrees. The spectra of dielectric reflectors are known to shift towards the “blue” side; thus, such a narrow transmission width at higher angles of incidence causes a significant amount of reflection of visible light, coloration and lowering the Tvis. Please see FIG. 1. FIG. 1 depicts the reflection spectra of U.S. Pat. No. 3,279,317 modeled on the information provided in the patent, indicating that a significant portion of the reflection shifts into the visible range when at a 45-degree angle of incidence versus the 0-degree angle of incidence depicted in the patent.

The NIR reflection range can be extended by using an additional interference stack centered at a different wavelength in the NIR. However, the additional reflection peak also causes a second order peak within the visible range causing a narrow transmission band not suitable for wide angle viewing. The effect of this can be seen in FIGS. 2 and 3; the two peaks at 950 nm and 1300 nm are superimposed as shown in FIG. 4. The width of the TR in FIG. 4 is approximately 300 nm where significant reflection occurs within the visible range.

It would be very advantageous to have a dielectric reflector targeted for the solar NIR range for wide viewing angles, with solar reflection performance similar to metal-based reflectors, which allows RF signals for electronic devices to pass through.

### SUMMARY OF INVENTION

In various aspects, the inventions described and claimed herein comprise infrared-reflecting films, or solar control films, that are useful, for example, to block infrared energy.

In one aspect, the invention relates to infrared-reflecting and solar control films that include a first dielectric stack, having: alternating layers of high and low refractive index materials of equal optical thickness; and at least one layer that is an odd multiple of the equal optical thickness, wherein the first dielectric stack has a reflection band centered at a wavelength from 850 nm to 1250 nm. The infrared-reflecting films of the invention further comprise a second dielectric stack, optically adjacent the first dielectric stack, having alternating layers of high and low refractive index materials of equal optical thickness; and at least a single layer that is an even multiple of the equal optical thickness, causing a double peak reflection band that is wider than the reflection band of the first dielectric reflector stack, and exhibits both a first peak and a second peak at a wavelength range from 800 nm to 1500 nm. The infrared-reflecting films of the invention may reflect at least 30% of electromagnetic waves over a wavelength range, for example, from 850 nm to 1500 nm. In another aspect, the infrared-reflecting film may reflect at least 30% of electromagnetic waves over a 600 nm wavelength range. In a further aspect, the infrared-reflecting film may transmit at least 85% of radio frequency wavelengths.

Further aspects of the invention are as disclosed and claimed herein.

### BRIEF DESCRIPTION OF THE DRAWINGS

FIG. 1 depicts reflection spectra modeled on the information provided in U.S. Pat. No. 3,279,317, in which a significant portion of the reflection shifts into the visible range when the angle of incidence is shifted from normal to 45 degrees, typical view angles for glazings;

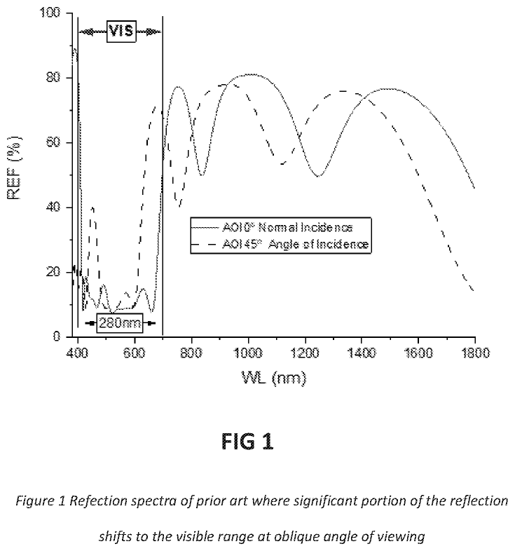

FIG. 2 depicts undesired higher order peaks that fall within the visible spectrum when using reflector stacks of equal optical thicknesses having a center peak at higher wavelengths, that could be used to make a reflection peak wider. These are due to optical interference effects;

FIG. 3 depicts reflectors tuned to 1050 nm and 1300 nm, respectively, showing an undesired reflection peak in the visible region that appears when the reflector is tuned to 1300 nm;

FIG. 4 depicts a wide reflector based on contiguous reflecting bands when the two stacks from FIG. 3 are combined;

FIG. 5 depicts an example of how to modify a single peak reflection band to create a multipeak reflection band by adding a center layer which is double the width of the other layers;

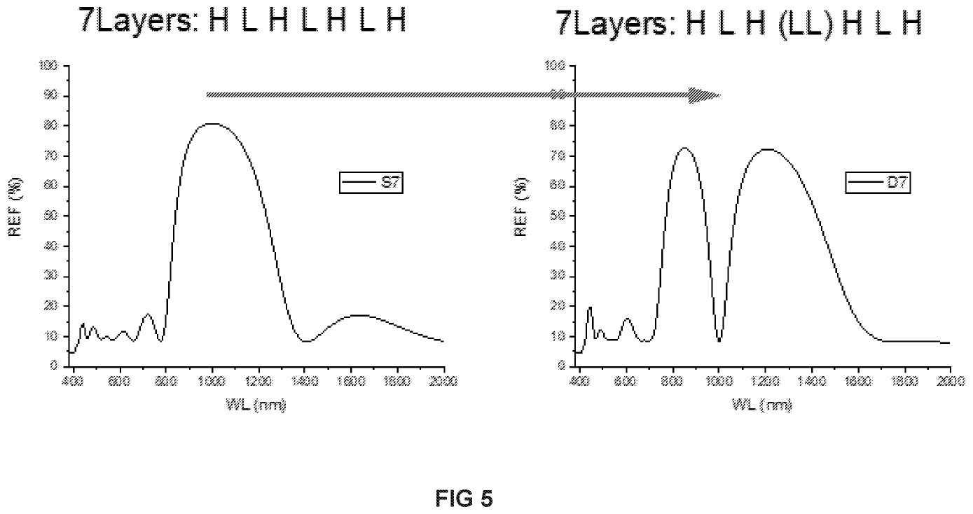

FIG. 6 depicts three reflection spectra, a single peak, a multipeak, and the single peak and double peak which may be combined by laminating the two layers into a single wide reflection construction;

FIG. 7 depicts an example with calculated performance values for a laminate according to the invention;

FIG. 8 depicts a single-peak reflection spectrum from a prototype.

FIG. 9 depicts a multipeak reflection spectrum from a prototype;

FIG. 10 compares the designed compound effect with the results obtained from the prototypes on each of the two sections;

FIG. 11 compares the total reflectance of the compound design with the results from the prototype;

FIG. 12 depicts the reflection spectra of the multipeak reflector for even and odd multiple thicknesses;

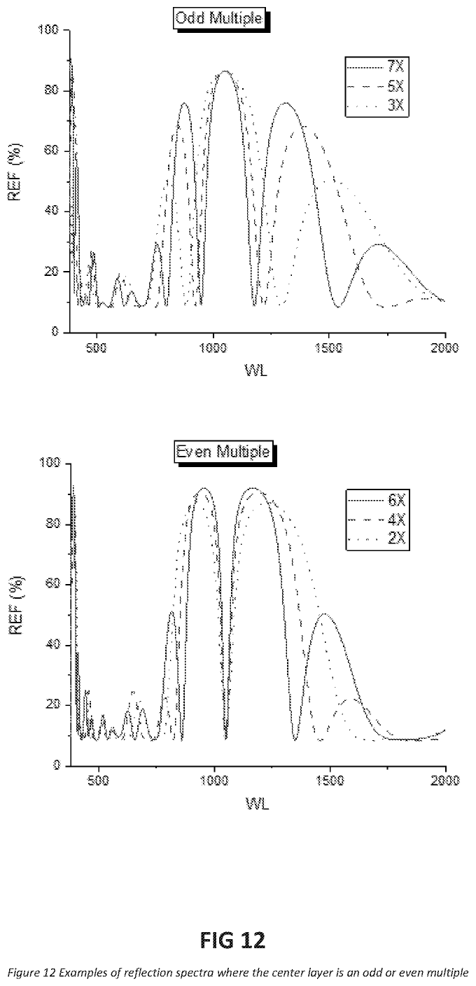

FIG. 13 is an example combining multipeaks: 2× combined with 5×.

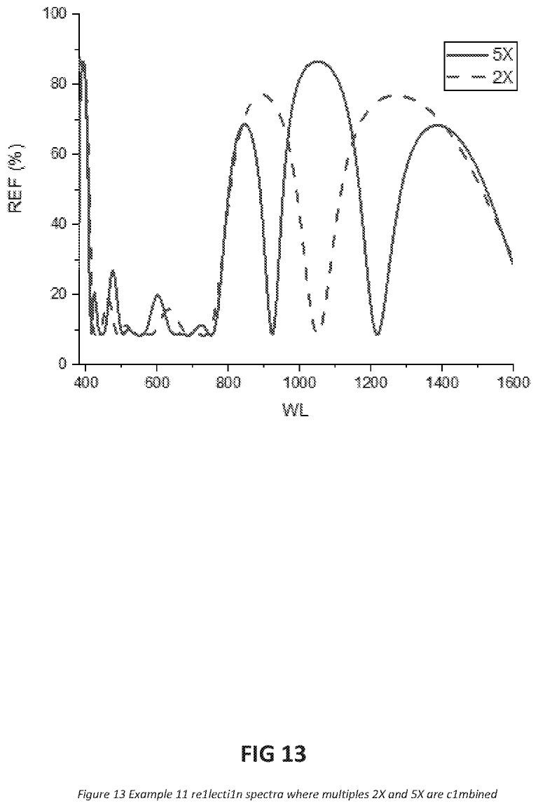

### DETAILED DESCRIPTION

Thus, in one aspect, the invention relates to infrared-reflecting films or solar control films that include a first dielectric stack and a second dielectric stack. The first dielectric stack has alternating layers of high and low refractive index materials of equal optical thickness, and at least one layer that is an odd multiple of the equal optical thickness. The first dielectric stack has a reflection band centered at a wavelength, for example, from 850 nm to 1250 nm when the multiple is one, or from 850 to 1500 when the multiple is 3 or 5.

The films of the invention may further comprise a second dielectric stack, optically adjacent the first dielectric stack, having alternating layers of high and low refractive index materials of equal optical thickness; and at least a single layer that is an even multiple of the equal optical thickness, causing a double peak reflection band that is wider than the reflection band of the first dielectric reflector stack, and exhibits both a first peak and a second peak at a wavelength range, for example, from 800 nm to 1500 nm. The infrared-reflecting films of the invention may reflect at least 30% of electromagnetic waves, for example over a wavelength range from 800 nm to 1500 nm, and may transmit at least 70% of electromagnetic waves over a wavelength range from 400 nm to 750 nm. The infrared-reflecting film may reflect at least 30% of electromagnetic waves over a 600 nm wavelength range.

The optical thickness of the layers of these dielectric stacks are tuned to about a quarter wave of a peak in the NIR, or a multiple of it, as already noted. When these stacks are tuned to provide substantial transmission in the visible range, they may have low but significant reflection in the visible range. There are cases where the reflected color needs to be adjusted without significant change in the NIR reflection nor visible light transmission.

For example, in windshields, the color of reflection at various angles of incidence varies and needs to be neutral or lightly colored. The reflected color may be seen as small ripples in the visible part of the reflection spectra. As described, the thickness of the layers in the stack are substantially close to a quarter wave, or multiple thereof, to contribute the NIR reflection. However, the layer thicknesses can be deviated from, in small amounts, to adjust the reflection spectra in the visible region, thus the reflected color.

Color adjustment at various angles of incidence may also be obtained by additional layers that are substantially thinner than the quarter-wave thickness, to adjust the visible reflection without affecting the NIR reflection. The additional layer or pair of layers should typically be less than about eighth-wave (less than about 90 nm) or less than about one sixteenth-wave (less than about 45 nm). The index of the material should provide an index contrast, where a high index layer should follow a low index layer, and a low index layer should follow a high index layer. The fine thickness adjustment of the layers may be obtained by computer refinement. In such embodiments, as few as one or two layers of differing refractive indices may be used.

The following embodiments and combinations are included within the scope of the invention:

1. A solar-control film, comprising:
a first dielectric stack having:
alternating layers of high and low refractive index materials of a first equal optical thickness; and
at least one layer that is an odd multiple of the first equal optical thickness,
wherein the first dielectric stack has a reflection band centered at a wavelength from 800 nm to 1500 nm; and
a second dielectric stack, optically adjacent the first dielectric stack, having:
alternating layers of high and low refractive index materials of a second equal optical thickness; and
at least a single layer that is an even multiple of the second equal optical thickness, causing a double peak reflection band that is at least as wide as the reflection band of the first dielectric reflector stack, and that exhibits both a first peak and a second peak at a wavelength range from 800 nm to 1500 nm.

2. The solar-control film of embodiment 1, wherein the solar-control film reflects at least 30% of electromagnetic waves over a wavelength range from 850 nm to 1500 nm.

3. The solar-control film of any of the preceding embodiments, wherein the solar-control film reflects at least 30% of electromagnetic waves over a 600 nm wavelength range.

4. The solar-control film of any of the preceding embodiments, wherein the solar-control film transmits at least 85% of radio frequency wavelengths.

5. The solar-control film of any of the preceding embodiments, wherein a peak of the reflection band of the first dielectric stack falls between the first peak and the second peak of the reflection band of the second dielectric stack.

6. The solar-control film of any of the preceding embodiments, wherein the solar-control film transmits at least 90% of radio frequency wavelengths.

7. The solar-control film of any of the preceding embodiments, wherein the solar-control film exhibits a Tvis of at least 70%.

8. The solar-control film of any of the preceding embodiments, wherein the odd multiple of the first equal optical thickness is a multiple selected from 1, 3, 5, 7, or 9.

9. The solar-control film of any of the preceding embodiments, wherein the even multiple of the second equal optical thickness is a multiple selected from 2, 4, 6, 8, or 10.

10. The solar-control film of any of the preceding embodiments, wherein the at least one layer that is an odd multiple of the first equal optical thickness is a single optical thickness.

11. The solar-control film of any of the preceding embodiments, wherein the single layer that is an even multiple of the second equal optical thickness is double the equal optical thickness.

12. The solar-control film of any of the preceding embodiments, wherein the solar-control film reflects at least 40% of electromagnetic waves over a wavelength range from 800 nm to 1500 nm.

13. The solar-control film of any of the preceding embodiments, wherein the solar-control film reflects at least 45% of electromagnetic waves over a wavelength range from 800 nm to 1500 nm.

14. The solar-control film of any of the preceding embodiments, wherein the solar-control film reflects at least 50% of electromagnetic waves over a wavelength range from 800 nm to 1500 nm.

15. The solar-control film of any of the preceding embodiments, wherein the solar-control film exhibits a Tvis of at least 80%.

16. The solar-control film of any of the preceding embodiments, wherein the solar-control film exhibits a Tvis of at least 90%.

17. The solar-control film of any of the preceding embodiments, wherein the first dielectric reflector stack and the second dielectric reflector stack are deposited on the same substrate.

18. The solar-control film of any of the preceding embodiments, wherein the first dielectric reflector stack and the second dielectric reflector stack are deposited on separate substrates that are laminated to form the solar-control film.

19. The solar-control film of any of the preceding embodiments, wherein the first dielectric reflector stack comprises from 3 to 11 layers.

20. The solar-control film of any of the preceding embodiments, wherein the second dielectric reflector stack comprises from 5 to 11 layers, and wherein the single layer that is an even multiple of the second equal optical thickness is one of three middle layers.

21. The solar-control film of any of the preceding embodiments, wherein the broad-band reflecting film exhibits a solar reflection of at least 20%.

22. The solar-control film of any of the preceding embodiments, wherein the layers of high refractive index materials have a refractive index of at least 2.

23. The solar-control film of any of the preceding embodiments, wherein the layers of low refractive index materials have a refractive index of less than 1.5.

24. The solar-control film of any of the preceding embodiments, wherein the layers of high refractive index materials comprise one or more of: titanium oxides, niobium oxides, indium oxides, tantalum oxides, zinc sulfides, gallium nitrides.

25. The solar-control film of any of the preceding embodiments, wherein the layers of low refractive index materials comprise one or more of: silicon dioxides, magnesium fluorides, or calcium fluorides.

26. The solar-control film of any of the preceding embodiments, wherein the solar-control film reflects at least 70% of the electromagnetic waves over a wavelength range in the infrared from about 850 nm to about 1350 nm, and at least 50% of the electromagnetic waves over a wavelength range in the infrared from about 800 nm to about 1500 nm.

27. The solar-control film of any of the preceding embodiments, wherein the repeating layers of high and low refractive index materials of the first dielectric reflector stack are polymer layers.

28. The solar-control film of any of the preceding embodiments, wherein at least one of the first dielectric reflector stack and the second dielectric reflector stack comprises inorganic layers.

29. The solar-control film of any of the preceding embodiments, wherein the solar control-film further comprises one or more of a UV absorber, an IR absorber, or a UV blocker.

30. The solar-control film of any of the preceding embodiments, further comprising a mounting adhesive layer.

31. The solar-control film of any of the preceding embodiments, further comprising c) a color-correcting layer comprising at least two alternating layers of high and low refractive indices in which the optical thickness of each layer is less than about one-eighth wave thickness.

32. The solar-control film of any of the preceding embodiments, further comprising c) a color-correcting layer comprising at least two alternating layers of high and low refractive indices in which the optical thickness of each layer is less than about one-sixteenth wave thickness.

The invention thus relates to infrared-reflecting films that may comprise a first dielectric stack having alternating layers of high and low refractive index materials of equal optical thickness; and at least one layer that is an odd multiple of the equal optical thickness. This first dielectric stack has a reflection band centered, for example, at a wavelength from 800 nm to 1500 nm, or from 850 nm to 1500 nm, or from 900 nm to 1400 nm. The infrared-reflecting films of the invention may further comprise a second dielectric stack, optically adjacent the first dielectric stack, having alternating layers of high and low refractive index materials of equal optical thickness; and a single layer that is an even multiple of the equal optical thickness, causing a multi-peak reflection band that is wider and thus a complement to the reflection band of the first dielectric reflector stack, and exhibits peaks at positions at a wavelength range, for example, from 800 nm to 1500 nm. The infrared-reflecting films of the invention may reflect at least 35% of electromagnetic waves over a wavelength range from 800 nm to 1500 nm, or from 850 nm to 1500 nm, or from 900 to 1400 nm, and may transmit at least 70% of electromagnetic waves over a wavelength range from 400 nm to 750 nm.

The invention also relates to infrared-reflecting films that may comprise: a first dielectric stack, having alternating layers of high and low refractive index materials of equal optical thicknesses, having a reflection band centered at a wavelength, for example, from 850 nm to 1250 nm; and a second dielectric stack, having alternating layers of high and low refractive index materials, wherein a single one of the alternating layers is double the optical thickness of the other layers that are of equal optical thicknesses, causing a double peak reflection band that is wider than that of the first dielectric reflector stack, exhibits both a first peak and a second peak at a wavelength range, for example, from 800 nm to 1500 nm.

The films of the invention may reflect at least 30% or at least 35% of the electromagnetic waves over a wavelength range from 800 nm to 1500 nm, or at least 40%, or at least 50%, or at least 60%, or at least 70%. The infrared-reflecting films may transmit at least 85% of wavelengths in the radio frequency range, that is, longer than about 6 mm, or at least 90% of wavelengths in the radio frequency range, or at least 95%, or at least 99% of wavelengths in the radio frequency range.

The first dielectric reflector stack and the second dielectric reflector stack may be deposited on the same substrate, or the first dielectric reflector stack and the second dielectric reflector stack may be deposited on separate substrates that are laminated to form the infrared-reflecting film.

The first dielectric reflector stack and the second dielectric stack may each comprise from 3 to 11 layers, or from 5 to 9 layers, for example. The number of layers of each of the two stacks may be the same or different. Further, the layers that are multiples in optical thickness may be, when there are 11 total layers for example, layer 5, 6, or 7. Typically the number of layers will be an odd number of layers, and the layers that are multiples of the optical thickness will be near, or will be, the centermost layer.

According to the invention, the infrared-reflecting film is typically substantially transmissive of visible light, for example exhibiting a Tvis of at least 50%, or at least 75%, or at least 85%, or at least 90%, or at least 95%.

According to the invention, the infrared-reflecting films block significant amounts of solar energy, having a TSER, for example, of at least 60%, or at least 40%, or at least 30%. The TSER is the “Total Solar Energy Rejected”; it is the percentage of solar energy that is blocked from going thru the glazing. The TSER is calculated from the solar reflection and solar absorption spectra, as a normalized weighted average thru the glazing; the weight function is the solar energy spectra according to ASTM E-891. The Solar Reflection is calculated from the solar reflection spectrum, as a normalized weighted average from the radiation side of the glazing; the weight function is the solar energy spectra according to ASTM E-891. The TSER is the calculated solar reflection in addition to the fraction of solar absorption that is not re-irradiated into the interior; it is calculated according to the National Fenestration Rating Council NFRC 300 test method for determining the solar optical properties of glazing's. The TSER may be enhanced by the addition of IR absorbers that absorb solar energy that is not being reflected.

The infrared-reflecting films of the invention may use high refractive index materials, having a refractive index, for example, of at least 1.9, or at least 2, or at least 2.2.

The infrared-reflecting films of the invention may also use low refractive index materials, having a refractive index, for example, of less than 1.4, or less than 1.5, or less than 1.6.

Examples of high refractive index materials useful according to the invention include one or more of: indium oxides, niobium oxides, titanium oxides, zinc sulfides, tantalum oxides, gallium nitride, mixed compounds, and the like.

Further, examples of low refractive index materials useful according to the invention include one or more of: silicon dioxides, magnesium fluorides, calcium fluorides, and the like.

According to the invention, the infrared-reflecting films may reflect, for example, at least 70% of the electromagnetic waves over a wavelength range in the infrared from 850 to 1350 nm, or at least 50% of the electromagnetic waves over a wavelength range in the infrared from about 800 nm to about 1500 nm,

The repeating layers of high and low refractive index materials of the first dielectric reflector stack may be polymer layers. At least one of the first dielectric reflector stack and the second dielectric reflector stack may comprise inorganic layers.

The IR-reflecting films of the invention may have a Rsol or solar reflection of at least 20%, or at least 25%, or at least 30%, or at least 35%, of the solar energy contacting the film. The Rsol or solar reflection is the percentage of solar energy that is reflected away from the glazing. The Rsol is calculated from the solar reflection spectrum, as a normalized weighted average thru the glazing; the weight function is the solar energy spectra according to ASTM E-891. The solar reflection is calculated according to the National Fenestration Rating Council NFRC 300 test method for determining the solar optical properties of glazing's.

The invention relates to solar control films that may comprise solar control particles, for example provided in or on a substrate, for example in a solar-absorber layer, adhesive layer, or elsewhere in the films of the invention. The solar-absorber layer is optically or functionally adjacent the dielectric stack layer, meaning that light and electromagnetic waves pass through both in order to achieve the desired function.

These solar control particles may comprise, for example, one or more of various inorganic metal compounds, in particular borides, nitrides, or oxides, that may be dispersed within a resin binder to form coatings that reflect or absorb particular wavelength bands of infrared energy and allow high levels of transmission of visible light. In particular, U.S. Pat. No. 6,663,950, the relevant disclosure of which is incorporated herein by reference, discloses that antimony doped tin oxide (ATO) has a very low transmission to infrared light having a wavelength exceeding 1400 nm, and U.S. Pat. No. 5,518,810, the relevant disclosure of which is incorporated herein by reference, discloses coatings containing tin doped indium oxide (ITO) particles that substantially block infrared light with having wavelength above 1000 nm, but the crystal structure of ITO particles can be modified to block light having wavelengths of down to 700-900 nm. U.S. Pat. No. 6,060,154, the relevant disclosure of which is incorporated herein by reference, discloses the use of fine particles of ruthenium oxide, tantalum nitride, titanium nitride, titanium silicide, molybdenum silicide and lanthanum boride to block light in the near infrared range. It also discloses the use of a plurality of different films each selectively transmitting light.

As used herein, nanoparticles are useful according to the invention, and refer to particles generally having an average particle size 200 nm or less, or less than 100 nm, or from 10 nm to 400 nm, or from 30 nm to 150 nm, or from 50 nm to 200 nm.

In one aspect, the solar control particles may be one or more of Antimony Tin Oxide (ATO), Indium Tin Oxide (ITO), or Tin Oxide, or doped versions thereof. Thus, the nanoparticles may comprise ATO and the coating layer applied to the substrate may contain, for example, from 30-60% by weight of ATO, or from 50-60% by weight of ATO. The concentration of the particles is typically selected to provide absorption of solar energy in the NIR range; the solar performance is measured as TSER. The amount of particles is measured as areal density in grams per square meter. For example, about 1 to 9 g/mt2 of ATO particles will provide from about 20% to about 40% TSER.

Alternatively, or in addition, the solar control particles may comprise modified ITO as is described, for example in U.S. Pat. No. 5,807,511, the relevant disclosure of which is incorporated herein by reference, and/or at least one of a metal hexaboride taken from lanthanum series of the periodic table, the preferred hexaborides are La, Ce, Pr, Nd, Gb, Sm, and Eu with La being the most preferred option.

If a coating layer is used, the binder may be a thermoplastic resin such as an acrylic resin, a thermosetting resin such as an epoxy resin, an electron beam curing resin, or preferably a uv curable resin which may be an acrylate resin of the type disclosed in U.S. Pat. No. 4,557,980, the relevant disclosure of which is incorporated herein by reference, or preferably a urethane acrylate resin.

This layer is electrically non-conductive which makes it particularly useful for applications relating to automobile windshields or rear windows especially those containing radio aerials.

This layer may be coated to a transparent polymeric film substrate, preferably a polyester film which is more preferably polyethylene terephthalate (PET) film. The solar-absorbing coating or infrared-blocking coating forms a hardcoat for the film substrate which is particularly advantageous and may cut out a further processing step during composite film manufacture. The PET film may be coated with an adhesive for fixing the film composite to for example an existing window of a building or automobile. The PET film and/or adhesive may include at least one uv radiation absorbing material to block out substantially all uv radiation to less than 1% weighted UV transmission.

Alternatively, or in addition, the solar control particles may comprise, for example, particles disclosed and claimed in U.S. Pat. No. 8,083,847, the relevant disclosure of which is incorporated herein by reference. Thus, according to the invention, fine particle dispersions may be used having visible light transparency, formed by dispersing fine particles of an infrared-shielding material in a medium, wherein the fine particles of the infrared-shielding material are tungsten oxide composite fine particles expressed by a general formula MₓW_{y}O_{z}, where M is at least one element selected from the group consisting of H, an alkali metal, an alkaline earth metal, a rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi, I and a mixture thereof; W is tungsten; O is oxygen; and the general formula MₓW_{y}O_{z} may satisfy 0.001≤x/y≤1 and 2.2z/y≤3.0; a particle diameter of the infrared-shielding material, may be, for example, not less than 1 nm and not more than 800 nm; and the medium is resin typically a resin, that is, is deposited on or in the substrate. In one aspect, the particles may comprise cesium-doped tungsten oxide.

These fine particles may comprise at least one kind of fine particles of hexagonal, tetragonal, or cubic crystal structure, typically a hexagonal crystal structure.

According to the above, the element M may be at least one of Cs, Rb, K, TI, In, Ba, Li, Ca, Sr, Fe and Sn, and the fine particles may be coated with an oxide containing at least one kind of element selected from the group consisting of Si, Ti, Zr and Al.

The medium may be a resin comprising at least one polymer selected from the group consisting of polyethylene resin, polyvinyl chloride resin, polyvinylidene chloride resin, polyvinyl alcohol resin, polystyrene resin, polypropylene resin, ethylene-vinyl acetate copolymer, polyester resin, polyethylene terephthalate resin, fluorine resin, polycarbonate resin, acrylic resin and polyvinyl butyral resin.

The dispersion may be formed by dispersing fine particles of an infrared-shielding material in a medium, wherein the fine particles of the infrared-shielding material are tungsten oxide composite fine particles expressed by the general formula: MₓW_{y}O_{z} where M is at least one kind of element selected from the group consisting of H, He, an alkali metal, an alkaline earth metal, a rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi, I and a mixture thereof; W is tungsten; O is oxygen, the method comprising the step of: heating a starting material of the fine particles of the infrared-shielding material in a reductive gas and/or inert gas atmosphere.

The starting material of the fine particles of infrared-shielding material may be heated, for example, at 100° C. to 850° C. in a reductive gas atmosphere and subsequently heated at 650° C. to 1200° C. in an inert gas atmosphere. The starting material of the fine particles of the tungsten oxide composite expressed by the general formula, MₓW_{y}O_{z} may be a powder obtained by mixing a powder of the element M or a compound containing the element M with more than one kind of powder selected from the group consisting of: a tungsten trioxide powder; a tungsten dioxide powder; a powder of tungsten oxide hydrate; a tungsten hexachloride powder; an ammonium tungstate powder; a powder of tungsten oxide hydrate obtained by dissolving tungsten hexachloride in an alcohol and then drying the solution; a powder of tungsten oxide hydrate obtained by dissolving tungsten hexachloride in an alcohol, adding water to the solution to form a precipitate, and drying the precipitate; a powder of tungsten compound obtained by drying an aqueous solution of ammonium tungstate; and a metal tungsten powder. This powder may be obtained, for example, by mixing an alcohol solution of tungsten hexachloride or an aqueous solution of ammonium tungstate with a solution of a compound containing the element M, and drying the mixture.

For example, the powder may be obtained by: mixing a powder of either the element M or a compound containing the element M, or a solution of a compound containing the element M, with a dispersion solution, the dispersion solution obtained by dissolving tungsten hexachloride in an alcohol and adding water to the solution to form a precipitate; and drying the mixture.

Other solar control particles and coating layers useful according to the invention include those disclosed in U.S. Pat. No. 7,585,436. Thus, the solar-absorbing layer may comprise a poly(ethylene terephthalate) film comprising lanthanum hexaboride and an epoxy agent, for example one selected from diepoxides of poly(oxypropylene)glycol, 2-ethylhexyl glycidyl ether, and diepoxide products of epichlorohydrin and polypropylene glycol. The lanthanum hexaboride particles useful according to the invention may be present in amounts, for example, from about 0.01 to about 0.2 weight percent of said film, or in an amount of 0.01 to 0.15 weight percent of said film, or with an areal density from about 0.01 g/mt2 to about 0.25 g/mt2.

The preparation of lanthanum hexaboride and its incorporation into or onto polymeric substrates is well known in the art (see, for example, U.S. Pat. Nos. 6,620,872 and 6,911,254). Lanthanum hexaboride is available, for example, as a dispersion of solid particles in liquid, with zirconium and dispersion agents included as appropriate.

Lanthanum hexaboride can be incorporated into polymer films of the present invention in any suitable amount, and will generally be incorporated in an amount that is sufficient to provide the desired near infrared absorbance without also excessively impacting optical performance. In various embodiments, lanthanum hexaboride may be, for example, incorporated into films in amounts of 0.01 to 0.2 weight percent, 0.01 to 0.15 weight percent, or 0.01 to 0.1 weight percent, or from 0.005 to 1.5 weight percent. In embodiments in which other infrared absorbers are used, the amount of lanthanum hexaboride may be reduced appropriately. Examples of other useful infrared absorbers include indium tin oxide and doped tin oxide, among others. In embodiments in which lanthanum hexaboride may be distributed in a binder layer or a hard coat, lanthanum hexaboride may be, in various embodiments, incorporated into polymer films at less than 3% by weight, preferably less than 2%, and more preferably between 0.5%-2%

Lanthanum hexaboride can be incorporated into polymer films by directly mixing with polymeric precursors prior to film formation. Lanthanum hexaboride can be incorporated onto poly(ethylene terephthalate) films, by, for example, spray techniques, gravure techniques, or dipping techniques, among others. In other embodiments, lanthanum hexaboride can be incorporated into a hard coat material, as described elsewhere herein in detail. Hard coats are often employed with polymer films to enhance scratch resistance and other characteristics (see, for example, U.S. Pat. No. 6,663,950). In other embodiments, lanthanum hexaboride can be incorporated into a binder material that is used to bind two polymer films together to form a multiple layer film, as is well known in the art.

Lanthanum hexaboride and other particles that are useful in the present invention can be nano-sized, ground particles, for example, less than 250 nanometers, less than 200 nanometers, less than 150 nanometers, or less than 100 nanometers in size.

Lanthanum hexaboride can be combined with antimony tin oxide, indium tin oxide, or tin oxide, and added to a binder layer or hardcoat of a polymer film.

Antimony tin oxide may thus be used, and the binder layer or hardcoat may contain 30-60% by weight of antimony tin oxide, or 50-60% by weight of antimony tin oxide, and less than 3% by weight of lanthanum hexaboride, or less than 2%, or from 0.5%-2%. The weight percent of lanthanum hexaboride may be, for example, 1.08%-3.53% the total weight percent of the sum of lanthanum hexaboride and antimony tin oxide.

The IR-reflecting films or solar-control films of the invention may further comprise one or more of a UV absorber, an IR absorber, or a UV blocker.

As used herein, the terms “infrared-reflecting film” and “solar-control film” may be used interchangeably, unless otherwise indicated.

The term “dielectric stack” as used herein refers to alternating layers of optical coatings having different refractive indices that may be built up, for example inorganic layers, on a polymer film. Alternatively, they may be stacks of polymers having alternating layers of different refractive index. The interfaces between these layers produce phased reflections, selectively reinforcing certain wavelengths of light and interfering with others. These layers are typically added by vacuum deposition. By controlling the thickness and the number of layers, the wavelength of the passband of the filter can be adjusted.

The invention thus relates to an infrared-reflection film that may include a dielectric stack, described herein as the second dielectric stack, of alternating low-high refractive index and which exhibits a double (or multipeak) reflection. The double or multipeak reflection may be achieved by use of one or more “modified’ quarter-wavelength dielectric stacks wherein a near-central low or high index layer is an even multiple of the optical thickness of the other layers of the stack. We have found according to the invention that if an even multiple of the equal optical thickness is used, a double-peaked reflection, that is wider in reflection range compared to a quarter wave stack, primarily occurs. This second dielectric stack may be simply laminated to a film with a quarter-wavelength dielectric stack with a single rejection peak (in the case where the odd multiple is 1), described herein as the first dielectric stack, to form a multilayer laminated film with a relatively wide near infrared reflection band. Alternatively, the odd multiple may be 3, 5, or 7, for example, in which case the number of peaks likewise will be 3. In any event, the first and second dielectric stacks may be deposited on the same substrate, or may be deposited on separate substrates that are thereafter laminated to one another providing a substantially wider reflection band in the NIR, compared to a quarter-wave stack. As used herein, the term NIR refers generally to wavelengths from about 780 nm to about 2500 nm.

The multilayer laminated films of the invention are improved over prior art wide band films with contiguous reflector stacks at different center peak locations which can generate harmonics, resulting in undesirable secondary reflection peaks in the visible spectrum. The final construction can include infrared absorbers and other dyes to improve the solar performance and/or adjust the visible light transmission and color if desired.

Typical solar-control coatings are based on the IR-reflective property of metals, such as silver. Metals reflect on a very wide range, including the full NIR section of the solar spectrum. However, metals reflect well beyond the NIR, including radio frequencies above 6 mm, therefore blocking the radio signals. Metals also reflect in the visible section; metals are typically used in conjunction with dielectrics to increase the transmission in the visible range.

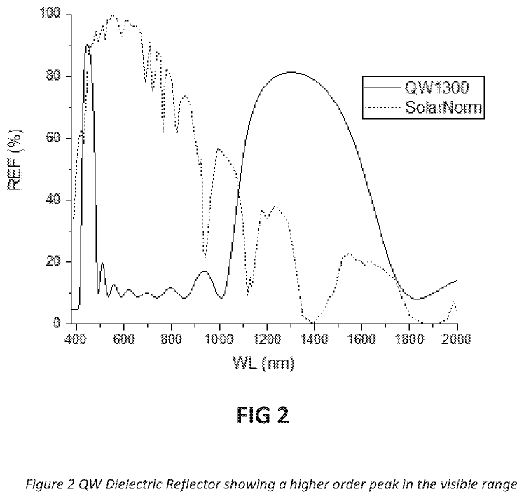

In contrast, dielectrics have typically lower reflection. Stacks of dielectrics are typically built to reflect on a band centered on a given wavelength. The thicknesses are designed to constructively form a reflection band in the NIR range of the solar spectrum. A typical dielectric reflector is built by stacking quarter-waves of transparent high contrast index of refraction materials tuned to the NIR. The level of reflection and the width of the reflection peak are functions of the number of layers and also the index contrast of the materials used. Even with the highest practical index contrast, the width of the peak falls short of the NIR section of the solar spectrum. One solution is to place multiple contiguous reflector stacks at different center peak locations to make the reflection peak wider. However, due to optical interference effects, second or higher order reflection band harmonics are generated that cause undesirable secondary reflection peaks that fall within the visible section, as shown in FIG. 2.

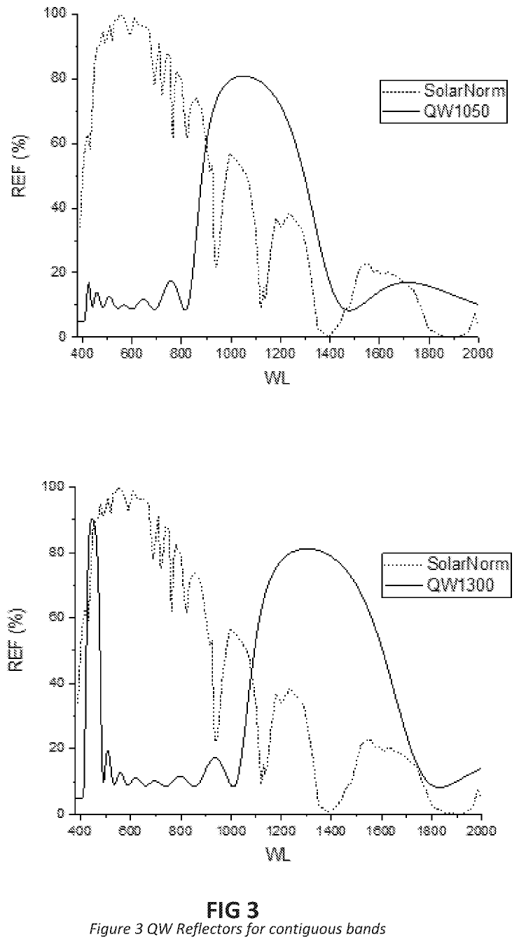

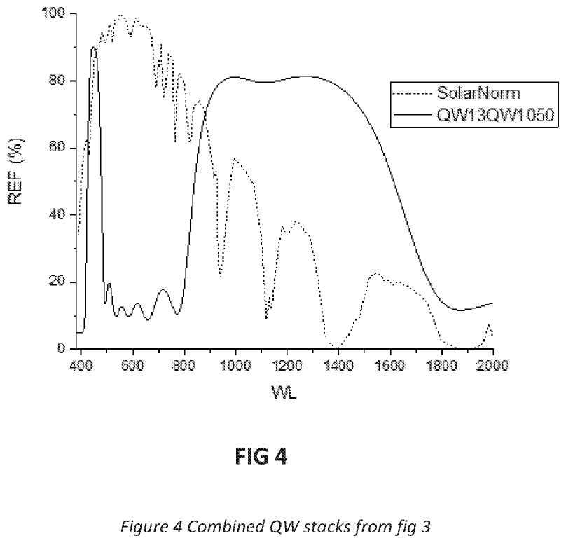

When building a wide reflector based on contiguous reflecting bands, we combine the two stacks from FIG. 3 and obtain the spectrum shown in FIG. 4. The reflector in FIG. 4 has good solar reflection properties; however, there is also an undesirable reflection peak that appears in the visible range due to the reflector tuned at 1300 nm from FIG. 3.

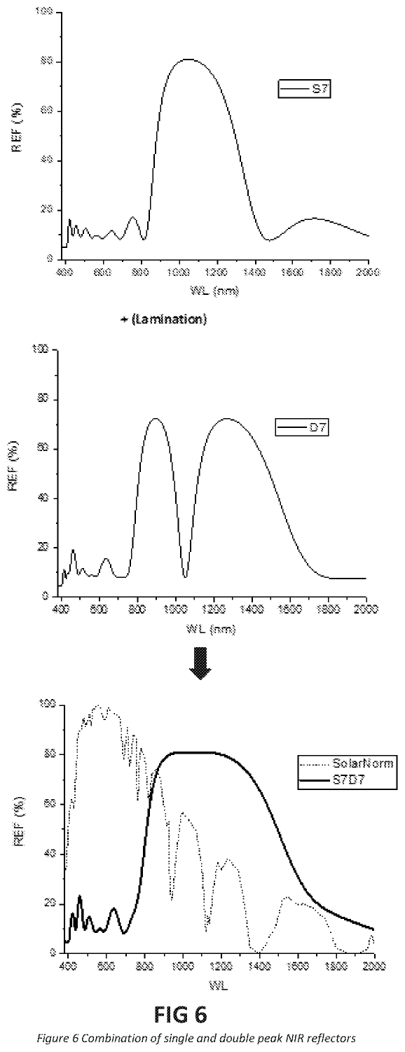

Thus, the invention relates in part to the use of double or multipeak reflectors where the performance is further improved by lamination with a dielectric stack having a single peak at the location between the peaks of the multipeak reflector while maintaining sufficient transmission width in the visible range. The example in FIG. 6 shows the basic construction where the overall width of the reflecting band is increased.

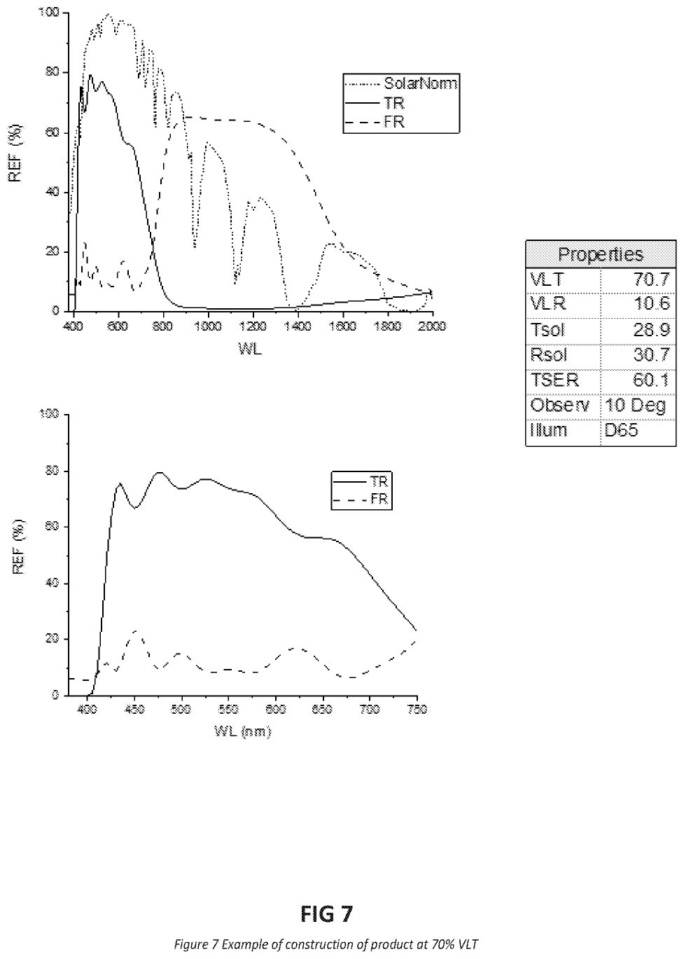

Note that the wider reflector as shown in FIG. 6 covers much of the solar energy radiation of interest, which is the reason the metal-based reflectors are typically higher in IR reflection. However, the construction becomes transparent beyond the solar energy wavelengths of interest; that is, it is transparent to RF signals. The wavelengths of interest are shown in FIG. 7 for a 70% visible light transmission from the current invention compared to the solar energy spectrum.

When we say that the dielectric stacks may selectively reflect infrared or NIR light, we mean that it is designed to reflect wavelengths from the nominal red edge of the visible spectrum around 700 nanometers and above, or from about 700 to about 2500 nm, or from 700 nm to 1750 nm, that is, above the visible light spectrum. Reflective layers that selectively reflect in this wavelength range are understood to block solar radiation, since the wavelengths that are reflected will not, for example, enter an automobile so as to heat up the interior.

Thus, “Visible radiation” or “visible light” means electromagnetic radiation having a wavelength of from about 380 nanometers to about 750 nanometers, or from about 400 nanometers to about 700 nanometers, while “Infrared radiation” or “heat” means electromagnetic radiation having a wavelength above about 700 nanometers, or above about 750 nanometers, or as described elsewhere herein.

UV radiation may be considered to be electromagnetic radiation having wavelengths from about 100 to 400 nm, or from 100 to 380 nm, or from 100 nm to 315 nm.

“Transparent” means having the property of transmitting visible light, unless otherwise stated.

“Tvis” or “Tv” or “Transmittance visible” each refer to a measure of transmittance over the visible wavelength. It is an integrated term covering the area under the transmittance vs. wavelength curve throughout the visible wavelengths and weighted to the sensitivity of the human eye. (1931 CIE Illuminant A Standard). In automotive windshield glazing, Tvis should be 70% or greater.

“Tsol” or “Ts” or “Transmittance solar” each refer to a measure of transmittance over all solar energy wavelengths. (ASTM E 424A) It is an integrated term covering the area under the transmittance vs. wavelength curve for both visible and infrared wavelengths. In many heat reflecting films, and glazings incorporating them, it is a primary goal to decrease Tsol while maintaining Tvis as high as possible.

“Transparent metal layers” are homogeneous coherent metallic layers composed of silver, gold, platinum, palladium, aluminum, copper or nickel and alloys thereof of a thickness which permits substantial transparency. Transparent metal layers are known to block radio frequencies.

“Transparent metal oxide layers” are layers made of compounds of metals reacted with oxygen; metal oxide layers are typically transparent in the VIS and IR ranges.

“Vacuum deposition” includes physical vapor deposition, chemical vapor deposition, plasma-enhanced chemical vapor deposition and the like. “Sputter deposit” or “sputter-deposited” refers to the physical vapor deposition process or the product of the process in which a layer of material is laid down by the use of a magnetron sputtering source, “Plasma enhanced chemical vapor deposition” (PECVD) refers to the process in which a layer material is laid down by chemical vapor deposition by use of precursors and plasma sources.

“Dielectrics” are nonmetallic or inorganic materials which are transparent to both visible and infrared radiation. Generally, these materials are inorganic oxides but other materials such as fluorides, sulfides, and organic polymers may be included as well.

“Optical thickness” as used herein is defined as the product of the physical thickness of the layer times the refractive index of the material used. The optical thickness is related to the optical path length and is a function of the refractive index of the material; it thus determines the phase of the light passing through the material.

“Contiguous” has its usual meaning of being in actual contact, i.e. of being adjoining. From time to time the somewhat redundant term “directly contiguous” is used for emphasis or clarification and has an identical meaning.

“Adjacent” means that the layers referred to are functionally adjacent, and especially optically adjacent, to one another. That is, layers are adjacent if, for example, light intended to pass through both layers indeed passes through both layers, with any layers lying between adjacent layers not blocking the intended function, in this case to pass light through the layers.

“Optically adjacent” thus means that the layers function together optically, that is, they are positioned in an optical path. The term “optically adjacent” thus allows for additional materials to be placed between optically adjacent layers, so long as they are in the same optical path.

When we say that the films of the invention have an optical path, we mean that there is a path that allows the light to pass through. Thus, if a layer is placed in the optical path, it will be to at least some or a significant extent transparent. Any number of additional materials may be added to the optical paths of the films of the invention so long as they do not detract from the desired effect.

The present invention thus relates to infrared- or heat-reflecting dielectric stacks or layers, that serve as filters. A basic embodiment of these filters is a multilayer interference filter directly adhered to a transparent support.

In preferred embodiments of this filter, the transparent layers may be deposited by physical vapor deposition (PVD) for example sputter-deposited, plasma enhanced chemical vapor deposition (PECVD), as already described.

The thickness of the various layers in the stacks should be controlled to achieve an optimum balance between desired infra-red reflectance and desired visible radiation properties. The ideal thicknesses can also depend upon the nature of the transparent dielectrics employed.

Each of the transparent layers may be, for example, from about 100 to about 200 nanometers (nm) in thickness, with the total thickness of layers in the dielectric stack being, for example, from about 700 to about 1300 nm.

Although the transparent layers may be of equal thickness, this is not a requirement of the present invention. Similar optical thicknesses can be achieved when the difference in thickness between layers is about 5% to 15%, especially 10% thicker or thinner than other layers.

The layers can be deposited by vapor deposition methods, electron-beam deposition, and the like. Magnetron sputtering is a preferred deposition method, but any methods which can deposit 100 nm layers with 10% accuracy, for example, can be used.

The thicknesses selected will depend in part upon the index of refraction of the dielectric employed. High indexes of refraction values will typically be at least 2, while low index of refraction values will typically be less than about 1.5. In a general relationship, thicker layers may be called for with low index material while thinner layers are used with higher index material.

Examples of materials having high indices of refraction include titanium oxides, niobium oxides, indium oxides, tantalum oxides, zinc sulfides, and the like.

Examples of materials having low indices of refraction include silicon oxides, magnesium fluorides, calcium fluorides, yttrium fluorides, and the like.

Other typical inorganic dielectrics and their indexes of refraction are listed in sources such as Musikant, Optical Materials, Marcel Dekker, New York, 1985, pp. 17-96, and may be used.

The oxide dielectrics can be conveniently deposited by reactive sputtering techniques, although, if desired, chemical vapor deposition and other physical or chemical vapor deposition methods can be employed to apply the dielectric layers.

According to this aspect, each of the dielectric stacks is typically directly adhered to a transparent support. This support is many times thicker than the stack. This thick support may be important to the practice of the invention. The stack itself is at most only a few hundred nanometers thick and thus can have only minimal physical strength without the added support. Support can be selected from among the rigid and nonrigid but minimally stretchable transparent solids which can withstand the conditions of sputter deposition. Poly(ester) s including poly(ethylene terphthalate) and other terphthalate ester polymers, poly(urethanes), cellulose ester polymers, acrylic polymers, and poly(vinyl fluoride) s from about 1 or 2 mils to about 50 mils in thickness are representative examples of nonrigid, minimally stretchable films which may be employed. Poly(esters) and in particular poly(ethylene terphthalates) are a preferred group of film supports.

The stack may be directly adhered to the support. This can be carried out by sequentially applying the various layers of the stack directly to the support.

The macroscale transparent layers, be they a plastic or glass transparent support or an additional component (such as a glass layer laminated to a plastic supported film), do contribute to the performance and visual optics of the final product as will be shown in the examples.

In some settings, the desired optical properties of the reflective stack include maximum rejection (reflection) of heat (infrared wavelengths) with only less attention being paid to the amount of visible light transmitted or reflected. In other applications, specific degrees of visible light transmittance must be attained to meet government regulations; for example, in automotive windshields the Tvis must be 70% or greater in many regions. Typically, reflectance is below 30% at all wavelengths between 350 nm and 700 nm. This means that the reflectance would be, without any strong tint in reflection that could be found to be objectionable. In an idealized windshield, the reflectance would be 100% at the wavelengths outside the visible range to achieve maximum thermal rejection.

As previously noted, this aspect of the dielectric layers of the invention permits one to control the color of reflectance off of the filter. In many cases the property is used to attain color neutrality. With colored light this means a colored reflection or with white light a neutral reflection. This feature can be quantitated by the CIE L*a*b* 1976 color coordinate system, in particular the ASTM 308-85 method.

Using the L*a*b* system the property is shown by values for a* and b* near O for example a* from −4 to +1 and b* from −2 to +2 when using an Illuminant A light source.

This neutral color can also be illustrated by the shape of the absorbance/reflectance vs. wavelength curve

According to the invention, one or both of the dielectric stacks may be a polymer stack, as disclosed, for example, in U.S. Pat. No. 5,103,337, the relevant disclosure of which is incorporated herein by reference. In this aspect, the dielectric stack may comprise an optical interference film, made of multiple layers of polymers, which preferentially reflect wavelengths of light in the infrared region of the spectrum while being substantially transparent to wavelengths of light in the visible spectrum. Such an optical interference film includes multiple alternating layers of substantially transparent polymeric materials with differing indices of refraction.

As noted in U.S. Pat. No. 5,103,337, such multilayer films are also described in Alfrey et al, U.S. Pat. No. 3,711,176. When these polymers are selected to have a sufficient mismatch in refractive indices, the multilayer films cause constructive interference of light. This results in the film transmitting certain wavelengths of light through the film while reflecting other wavelengths. The multilayer films can be fabricated from relatively inexpensive and commercially available polymer resins having the desired refractive index differences. The films have the further advantage in that they may be shaped or formed into other objects.

As noted, the reflection and transmission spectra for a particular film are primarily dependent on the optical thickness of the individual layers, where optical thickness is the product of the physical thickness of the layer times its refractive index. Films can be designed to reflect infrared, visible, or ultraviolet wavelengths of light depending on the optical thickness of the layers. When designed to reflect infrared wavelengths of light, such prior art films also exhibit higher order reflections in the visible range, resulting in an iridescent appearance for the films.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

This invention can be further illustrated by the following examples of embodiments thereof, although it will be understood that these examples are included merely for purposes of illustration and are not intended to limit the scope of the invention unless otherwise specifically indicated.

### EXAMPLES

### Example 1. Modeled Examples

The individual thicknesses of the layers in both components or stacks may be tuned to obtain certain colors or other optical values. An example of a laminate is shown in FIG. 7 with the calculated performance values. The example in FIG. 7 is the simulation of a laminate of 7 layers double peak with a 7 layers single peak.

Another advantage is the reduced manufacturing risk; the lower number of optical layers for each laminate component significantly reduces the risk for errors on the overall yield on the final construction. This will allow for manufacturing in longer campaigns, reducing the overall cost of the product.

The final construction can include infrared absorbers and other dyes to improve the solar performance and/or adjust the color if required. Due to the very low or lack of absorption of dielectrics, the reflectors in this invention have very high visible light transmission. The high visible light transmission allows for the addition of infra-red absorbers significantly increasing the total solar energy rejected (TSER) compared to metal-based products.

A comparison of performance parameters calculated, and competitive products measured when applied on 3 mm glass is shown in table 1. Note from table 1 that the current invention, when used with specific high index contrast materials, outperforms the metal based NIR reflectors in some of the laminates as described in this invention. Also note the higher TSER values that can be obtained from this design.

TABLE 1

| | 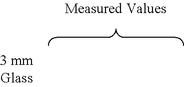 | | | 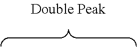 | | 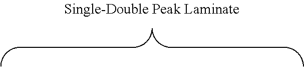 | | | | | | | |
|---|---|---|---|---|---|---|---|---|---|---|---|---|---|
| | Commercial | Commercial | Commercial | | | | | | | | | | |
| | Product A | Product B | Product C | Double Peaks | | Laminates (SN) | | | Laminates (MN) | | | | |
| Property | Dielectric | Metal Based | Metal Based | IRR9D | IRR5D | IRR5S5D | IRR7S7D | IRR5S7D | IRR3D3S | IRR5D3S | IRRSD5S | IRRSD3S COLOR-OPT | IRR7DSS |
| % Solar T | 38.10 | 36.30 | 38.90 | 29.8 | 29.25 | 28.22 | 28.13 | 28.82 | 28.30 | 29.95 | 29.50 | 28.99 | 29.87 |
| % Solar FR | 20.50 | 30.70 | 31.20 | 27 | 25.02 | 30.12 | 31.56 | 29.93 | 29.98 | 31.72 | 34.41 | 29.86 | 33.63 |
| % Solar BR | 13.50 | 37.10 | 38.00 | | | | | | | | | | |
| % Solar Abs | 43.40 | 33.00 | 30.00 | 43.1 | 45.71 | 41.66 | 40.3 | 41.25 | 43.71 | 38.32 | 36.08 | 41.14 | 36.49 |
| % VLT | 69.80 | 70.90 | 74.80 | 71.3 | 70.55 | 70.43 | 69.75 | 70.48 | 70.68 | 70.18 | 70.04 | 70.04 | 70.28 |
| % VLER | 8.60 | 8.40 | 8.70 | 10.2 | 9.23 | 10.12 | 11.05 | 11.05 | 9.88 | 13.44 | 11.38 | 10.24 | 13.30 |
| % VIBR | 8.30 | 8.20 | 9.00 | 9.1 | 8.52 | 9.0 | 9.89 | 9.58 | 8.97 | 10.28 | 10.31 | 9.30 | 10.14 |
| % TSER | 49.40 | 55.40 | 53.70 | 58.5 | 58.39 | 60.52 | 60.98 | 60.04 | 60.43 | 59.67 | 60.75 | 59.89 | 60.27 |

### Example 2. Prototyped Example

Due to the limited access to resources and pilot machines because of the ongoing pandemic; a prototype was built using a small batch machine for proof of concept. The sample was built based from two sections: section 1—single peak, and section 2—double peak. The sections 1 and 2 were built of 5-layer quarter wave reflectors each tuned in the near infrared. The design thicknesses for the two sections are given in Tables 2 and 3.

TABLE 2
Section 1 - Single Peak

| Layer # | Material | Thickness (nm) | QW |
|---|---|---|---|
| 5 | TiO2 | 116.97 | 1 |
| 4 | SiO2 | 181.33 | 1 |
| 3 | TiO2 | 116.97 | 1 |
| 2 | SiO2 | 181.33 | 1 |
| 1 | TiO2 | 116.97 | 1 |

PET Substrate

TABLE 3
Section 2 - Double Peak

| Layer # | Material | Thickness (nm) | QW |
|---|---|---|---|
| 5 | TiO2 | 116.97 | 1 |
| 4 | SiO2 | 181.33 | 1 |
| 3 | TiO2 | 233.94 | 2 |
| 2 | SiO2 | 181.33 | 1 |
| 1 | TiO2 | 116.97 | 1 |

PET Substrate

The batch machine doesn't have an in-situ thickness monitor, the layer thicknesses were calculated by scaling deposition time. Deposition time provides a method to deposit layers at certain thickness; however, the thickness is not very precise. For simplicity, the two sections were built with 5 layers each. The resulting spectra of the sections have a similar shape profile as the design. The thickness error was shifted similarly on both sections. The shift resulted in the NIR reflector peak shifted; nonetheless, the concept of combining the single and double peaks was successfully proven.

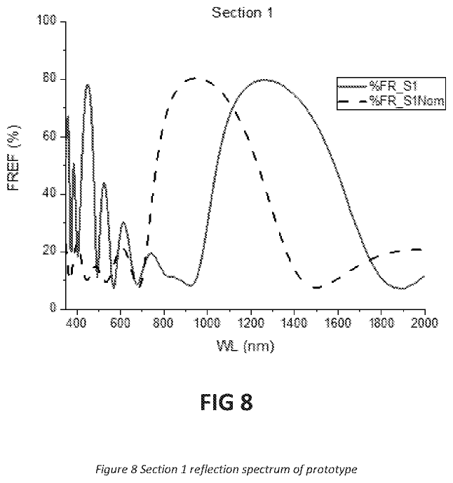

Table 4 and FIG. 8 are graphs and target thickness, and a comparison of designed thickness vs shifted thickness for section 1 is in Table 4.

TABLE 4
Section 1 - Single Peak

| | | Design | Actual | Thickness |
|---|---|---|---|---|
| Layer # | Material | Thickness (nm) | Thickness (nm) | Shift |
| 5 | TiO2 | 116.97 | 153 | 31% |
| 4 | SiO2 | 181.33 | 212.88 | 17% |
| 3 | TiO2 | 116.97 | 134.05 | 15% |
| 2 | SiO2 | 181.33 | 209.07 | 15% |
| 1 | TiO2 | 116.97 | 165.75 | 42% |

PET Substrate

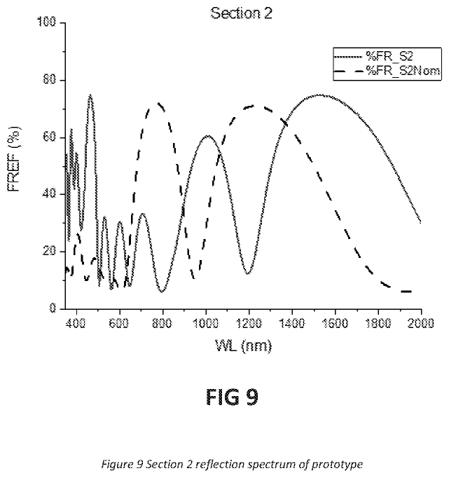

FIG. 9 and Table 5 are graphs and target thickness and a comparison of designed thickness vs shifted thickness for section 2. The center of the double peak and the peak intensity balance is shifted due to the thickness shift from the process:

TABLE 5
Section 2 - Double Peak

| | | Design | Actual | Thickness |
|---|---|---|---|---|
| Layer # | Material | Thickness (nm) | Thickness (nm) | Shift |
| 5 | TiO2 | 116.97 | 145.28 | 24% |
| 4 | SiO2 | 181.33 | 215.06 | 19% |
| 3 | TiO2 | 233.94 | 256.52 | 10% |
| 2 | SiO2 | 181.33 | 201.1 | 11% |
| 1 | TiO2 | 116.97 | 174.52 | 49% |

PET Substrate

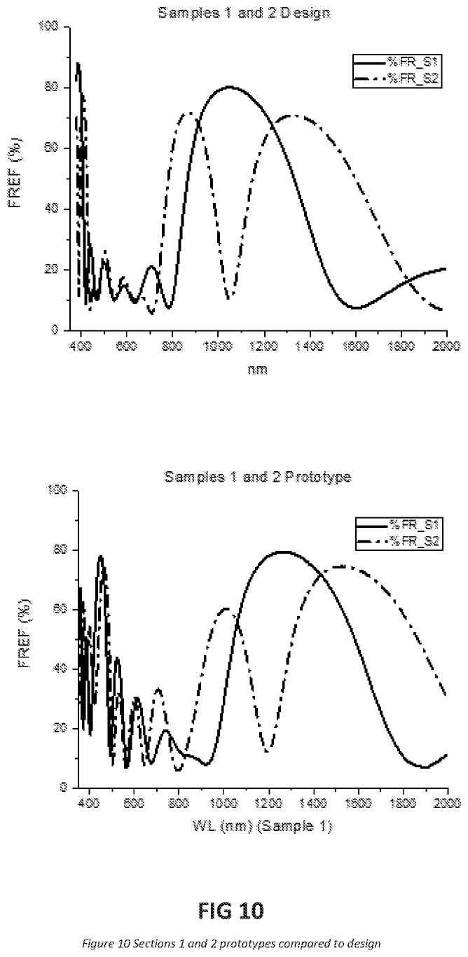

FIG. 10 shows the designed compound effect compared to results from the prototypes on each of the sections.

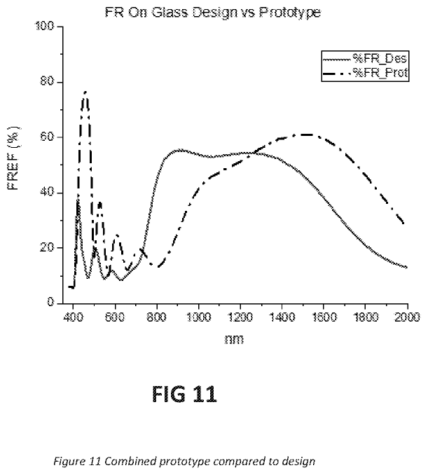

The total reflectance of the compound design is shown in FIG. 11; the designed spectra is compared to the prototype. It is noted that the overall wide shape of the reflector is very comparable to the design; however, the spectra is shifted to the right due to the similar shift on both sections.

1. A solar-control film, comprising:
a. a first dielectric stack having:
i. alternating layers of high and low refractive index materials of a first equal optical thickness; and
ii. at least one layer that is an odd multiple of the first equal optical thickness,
wherein the first dielectric stack has a reflection band centered at a wavelength from 800 nm to 1500 nm; and
b. a second dielectric stack, optically adjacent the first dielectric stack, having:
i. alternating layers of high and low refractive index materials of a second equal optical thickness; and
ii. at least a single layer that is an even multiple of the second equal optical thickness, causing a double peak reflection band that is at least as wide as the reflection band of the first dielectric reflector stack, and that exhibits both a first peak and a second peak at a wavelength range from 800 nm to 1500 nm.

2. The solar-control film of claim 1, wherein the solar-control film reflects at least 30% of electromagnetic waves over a wavelength range from 850 nm to 1500 nm.

3. The solar-control film of claim 1, wherein the solar-control film reflects at least 30% of electromagnetic waves over a 600 nm wavelength range.

4. The solar-control film of claim 1, further comprising c) a color-correcting layer comprising at least two alternating layers of high and low refractive indices in which the optical thickness of each layer is less than about a one-eighth wave thickness.

5. The solar-control film of claim 1, further comprising c) a color-correcting layer comprising at least two alternating layers of high and low refractive indices in which the optical thickness of each layer is less than about a one-sixteenth wave thickness.

6. The solar-control film of claim 1, wherein a peak of the reflection band of the first dielectric stack falls between the first peak and the second peak of the reflection band of the second dielectric stack.

7. The solar-control film of claim 1, wherein the solar-control film transmits at least 90% of radio frequency wavelengths.

8. The solar-control film of claim 1, wherein the solar-control film exhibits a Tvis of at least 70%.

9. The solar-control film of claim 1, wherein the odd multiple of the first equal optical thickness is a multiple selected from 1, 3, 5, 7, or 9.

10. The solar-control film of claim 1, wherein the even multiple of the second equal optical thickness is a multiple selected from 2, 4, 6, 8, or 10.

11. The solar-control film of claim 1, wherein the at least one layer that is an odd multiple of the first equal optical thickness is a single optical thickness.

12. The solar-control film of claim 1, wherein the single layer that is an even multiple of the second equal optical thickness is double the equal optical thickness.

13. The solar-control film of claim 1, wherein the solar-control film reflects at least 50% of electromagnetic waves over a wavelength range from 800 nm to 1500 nm.

14. The solar-control film of claim 1, wherein the solar-control film exhibits a Tvis of at least 80%.

15. The solar-control film of claim 1, wherein the first dielectric reflector stack and the second dielectric reflector stack are deposited on the same substrate.

16. The solar-control film of claim 1, wherein the first dielectric reflector stack and the second dielectric reflector stack are deposited on separate substrates that are laminated to form the solar-control film.

17. The solar-control film of claim 1, wherein the first dielectric reflector stack comprises from 3 to 11 layers.

18. The solar-control film of claim 1, wherein the second dielectric reflector stack comprises from 5 to 11 layers, and wherein the single layer that is an even multiple of the second equal optical thickness is one of three middle layers.

19. The solar-control film of claim 1, wherein the broad-band reflecting film exhibits a solar reflection of at least 20%.

20. The solar-control film of claim 1, wherein the layers of high refractive index materials have a refractive index of at least 2.

21. The solar-control film of claim 1, wherein the layers of low refractive index materials have a refractive index of less than 1.5.

22. The solar-control film of claim 1, wherein the layers of high refractive index materials comprise one or more of: titanium oxides, niobium oxides, indium oxides, tantalum oxides, zinc sulfides, gallium nitrides.

23. The solar-control film of claim 1, wherein the layers of low refractive index materials comprise one or more of: silicon dioxides, magnesium fluorides, or calcium fluorides.

24. The solar-control film of claim 1, wherein the solar-control film reflects at least 70% of the electromagnetic waves over a wavelength range in the infrared from about 850 nm to about 1350 nm, and at least 50% of the electromagnetic waves over a wavelength range in the infrared from about 800 nm to about 1500 nm.

25. The solar-control film of claim 1, wherein the repeating layers of high and low refractive index materials of the first dielectric reflector stack are polymer layers.
